(19) United States
(12) Patent Application Publication
(10) Pub. No.: US 2012/0016734 A1
(43) Pub. Date: Jan. 19, 2012

(54) METHOD AND COMPUTER SYSTEM FOR EVALUATING THE IMPACT OF AN ADVERTISING CAMPAIGN

(76) Inventor: Daniel Buchinger, Colmar (FR)

(21) Appl. No.: 13/259,158

(22) PCT Filed: Mar. 26, 2010
(86) PCT No.: PCT/IB2010/001189

§ 371 Date: Sep. 23, 2011

Related U.S. Application Data
(60) Provisional application No. 61/164,268, filed on Mar. 27, 2009.

(51) Int. Cl. G06Q 30/00

(52) U.S. Cl. 705/14.41

(57) ABSTRACT

A method and a computer system for evaluating an impact of an advertising campaign, defined by given campaign parameters, on a sales volume of a product comprising providing point-of-sale packaging, with given features and bearing at least one advertising message related to said product, to at least one retailer with a given profile, collecting data concerning the sales volume of the product, executing a processor to process and sort the data as a function of the given campaign parameters, the given profile of the at least one retailer, and the given features of the point-of-sale packaging, to obtain an evaluation of the impact of the advertising campaign on the sales volume of the product.

### BACKGROUND

Goods sold to customers by merchants are frequently placed into some kind of packaging (such as a shopping bag) at a store where the goods are sold. Any of a wide range of products may be placed into shopping bags, for example, at cash registers where the merchant's customers pay for the goods at the merchant's retail location. Because the customers need a way to carry away goods purchased, such shopping bags and packaging are usually purchased by the merchants as a cost of doing business.

While it is well known that retailers have an interest in promoting themselves to their customers (and hopefully encouraging repeat business), there is one opportunity for advertising and self-promotion that remains available. The packaging (including shopping bags) used by retailers typically fail to take advantage of the opportunity for advertising, marketing, and promotion. Shopping bags are generally plain white or printed with simple, generic information such as the name of the store.

At the same time, a wide variety of advertisers continually seeks to purchase and deliver advertising messages to customers through new arrays of advertising channels.

Furthermore, in many fields of trade and industry, systems and methods for monitoring and evaluating the performance of an advertising campaign related to a product or a service on a market may be used. Indeed, although the practice of identifying target markets and developing advertising campaigns to attract new consumers is a fairly developed practice, the ability to accurately and efficiently measure which advertising campaigns are most successful and what changes should be made in a advertising campaign to increase the overall effectiveness of the advertising campaign is a far-less developed area of industry.

### SUMMARY

In one aspect, embodiments disclosed herein relate to a method for evaluating an impact of an advertising campaign, defined by given campaign parameters, on a sales volume of a product comprising providing point-of-sale packaging, with given features and bearing at least one advertising message related to said product, to at least one retailer with a given profile, collecting data concerning the sales volume of the product, executing a processor to process and sort the data as a function of the given campaign parameters, the given profile of the at least one retailer, and the given features of the point-of-sale packaging, to obtain an evaluation of the impact of the advertising campaign on the sales volume of the product.

In another aspect, embodiments disclosed herein relate to a computer system for evaluating an impact of an advertising campaign, defined by given campaign parameters, on a sales volume of a product comprising a memory, a storage device configured to collect data concerning said sales volume of said product, a processor for executing instructions stored in the memory to process and sort said data as a function of the given campaign parameters, a given profile of at least one retailer, and given features of point-of-sale packaging, to obtain an evaluation of the impact of the advertising campaign on said sales volume of said product, wherein said point-of-sale packaging, with the given features and bearing at least one advertising message related to said product, are given to the at least one retailer with the given profile.

Other aspects and advantages of the embodiments disclosed herein will be apparent from the following description and the appended claims.

### BRIEF DESCRIPTION OF DRAWINGS

Advantages and characteristics of the present disclosure will be apparent from the following detailed description, referring to the figures in which:

FIG. 1 shows a web of relationships between several business entities according to embodiments of the present application.

FIG. 2 shows a general computing process according to embodiments of the present application.

FIG. 3 shows the interface of a database server according to embodiments of the present disclosure.

Table 1 comprises the sales data resulting from an example advertising campaign.

FIG. 4 shows the evolution of the sales volume according to an example of the present application.

FIG. 5 shows a computer system according to embodiments of the present disclosure.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Embodiments of the method, disclosed herein, are directed toward evaluating the impact of an advertising campaign, defined by given campaign parameters, on a sales volume of a product and involve providing point-of-sale packaging with given features and bearing at least one advertising message related to said product, to at least one retailer with a given profile, collecting data concerning the sales volume of the product, and executing a processor to process and sort the data as a function of the given campaign parameters, the given profile of the at least one retailer and the given features of the point-of-sale packaging, to obtain an evaluation of the impact of the advertising campaign on the sales volume of the product.

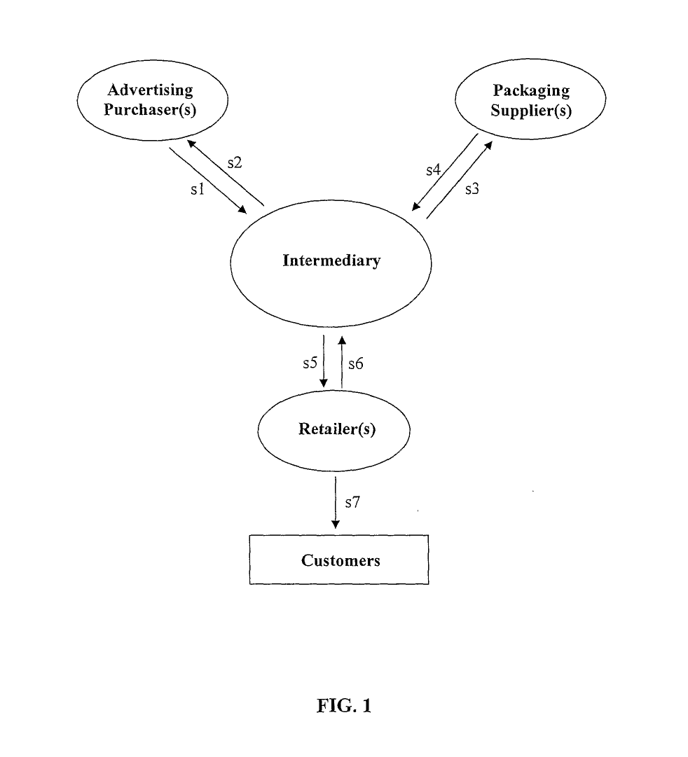

The method that embodies the disclosure of the present application is depicted in FIG. 1, which is a diagram showing a web of relationships between several entities.

These entities include at least one advertising purchaser which is or which represents a business entity that markets goods that the advertising purchaser would like to see advertised to consumers who purchase goods from another business entity. The advertising purchaser may itself be a manufacturer, seller, or provider of goods, or the advertising purchaser may be another entity (such as an advertising agency that purchases advertising on behalf of another entity). The advertising purchaser may be a pharmaceutical company, a jewel manufacturer, a cosmetic and perfumes company, a food, clothing or household goods corporation, etc. In an embodiment of the present disclosure, the advertising purchaser is a pharmaceutical company.

The advertising purchaser enters in a business relationship with an entity (e.g., a business entity, an agent for the business entity, etc.), which serves as an intermediary between at the at least one advertising purchaser and at least one retailer. The retailer sells goods to its own customers, to whom the advertising purchaser desires to deliver its own advertising messages.

In one or more embodiments of the invention, the intermediary is also in a business relationship with a packaging supplier. In other embodiments of the present disclosure, the intermediary may be the packaging manufacturer. The point-of-sale packaging, manufactured by the intermediary or that the packaging provider provides to the intermediary, bears advertising messages related to products sold by or otherwise of interest to the advertising purchaser. These goods are related to the goods sold by the retailer. The packaging supplier may manufacture the packaging itself or may purchase the packaging from an independent packaging manufacturer.

The point-of-sale packaging for the product may be of any kind. Examples include a shopping bag, box, carton, or other carrier or container in which goods would be placed at the time of purchase. In one embodiment of the present application, the point-of-sale packaging is a shopping bag having given features. The features may include its size and the number of faces bearing advertising messages. The point-of-sale packaging may be of any size, and may be classified in three categories: small, medium or large. The point-of-sale packaging may be provided with a handle. For example, the small shopping bags may have a width of 120 mm, a height of 270 mm and an extensible gusset length of 25 mm, the medium bags may have a width of 180 mm, a height of 330 mm and an extensible gusset length of 50 mm, and the large shopping bags may have a width of 260 mm, a height of 450 mm and an extensible gusset length of 60 mm. The point-of-sale packaging may made of any type of known materials, and for example the packaging may be in paper, cotton or plastic. In some embodiments, the point-of-sale packaging is environmentally friendly. In some other embodiments, the point-of-sale packaging is constituted of an oxo-biodegradable material. The advertising messages may be printed on or otherwise applied to the point-of-sale packaging, on only one or many faces. In some embodiments, the advertisement messages are printed using the four color model (CYMK color model) or the duotone model. Further, the logo of the intermediary may be printed on or otherwise applied to the point-of-sale packaging. Possibly, a legal advertisement authorization or warning, that needs to be provided by the advertisement purchaser for some particular products (for example, drugs) which indicates that the advertising messages are in accordance with the legal standards may be printed on or otherwise applied to the point-of-sale packaging.

The advertising point-of-sale packaging provides the advertising purchaser with a new communication media to pass on its advertising messages. Further, the advertising point-of-sale packaging also provides the advertising purchaser with new marketing tools as to how it may pass on its advertising messages using the point-of-sale packaging, such as the design of the printed advertising messages, other media, such as leaflets or product samples, which may be put on or inside the point-of-sale packaging.

The intermediary provides the point-of-sale packaging to the retailer in exchange for the retailer's agreement to place all its goods in the provided packaging when the retailer's goods are sold and delivered to its customers. The advertising purchaser benefits from this arrangement in that its advertising messages are communicated to the customers when the point-of-sale packaging is delivered to the customers in connection with sales volume of the retailer's goods. The retailer benefits by being provided a point-of-sale packaging, which it would otherwise need to purchase at its own expense, either free of charge or at a substantial discount to what it would normally be required to pay. Accordingly, the retailer reduces overhead while potentially helping educate its customers regarding products available in the marketplace.

The retailer might sell to its customers a wide range of products, possibly including pharmaceutical products, jewels, beauty care products, food items, clothing, household goods, or other such goods. Those goods would normally be placed into point-of-sale packaging at point-of-sale devices (e.g., cash registers) at the time those goods are delivered to the customers at the retailer's store locations. The retailer may be a drugstore, a jeweler, a beauty or perfume shop, a supermarket, etc. In an embodiment of the present disclosure, the retailer is a drugstore. The retailer may be characterized by a profile defined by one of its geographical location, its sales volume, and its number of clients per day. In one embodiment of the present application, the retailers are separated in three categories: the first category includes the retailers having from 100 to 249 clients per day (i.e., from 1 to 2 million Euros of annual sales volume), the second category includes the retailers having from 250 to 400 clients per day (i.e., from 2 to 4 million Euros of annual sales volume) and the third category includes the retailers having more than 400 clients per day (i.e., more than 4 million Euros of annual sales volume). In embodiments of the present disclosure, the advertising campaign targets only a part of a retailer's customers.

As illustrated on FIG. 1, the advertising purchaser provides the intermediary with all the characteristics of the planned advertising campaign, i.e., advertising messages, features of the point-of-sale packaging, number of point-of-sale packaging elements provided to the retailers, length of the campaign, locations and size of the retailers, (s1). The intermediary then orders the point-of-sale packaging from the packaging supplier (s3), which provides the intermediary with point-of-sale packaging bearing the advertising messages (s4). Further, the intermediary provides the advertising point-of-sale packaging to the retailer (s5) who uses the point-of-sale packaging to deliver goods to its customers (s7).

The relationship between the advertising purchaser, the retailer, and the intermediary may include another characteristic, which is that the intermediary gathers sales data from the retailer (s6) to provide the advertising purchaser with an evaluation of the impact of its advertising campaign on the retailer's sales volume (s2).

The intermediary first collects (either manually or using a computing device such as from the at least one retailer's server (8)), the sales data of the advertised product before, during, and after the advertising campaign. The collected data may be daily, weekly, or monthly sales data. The sales data collected before the campaign enable the intermediary to define a baseline which allows evaluation of the evolution of the sales volume during and after the campaign. The data collected during the campaign allows for measuring the immediate impact of the campaign. Finally, the sales data gathered after the campaign allows evaluation of any residual effect on the advertised product's sales volume. In one or more embodiments of the invention, the duration of the collection depends on the length of the advertising campaign. The sales data are collected a predetermined period before and after the advertising campaign, typically during between 2 to 8 weeks before and after the advertising campaign. The advertising campaign spans a predetermined period, typically from 2 to 8 weeks. In one embodiment of the present disclosure, the advertising campaign has a duration of 4 weeks, and the sales data are collected during 8 weeks prior to the advertising campaign and 8 weeks after.

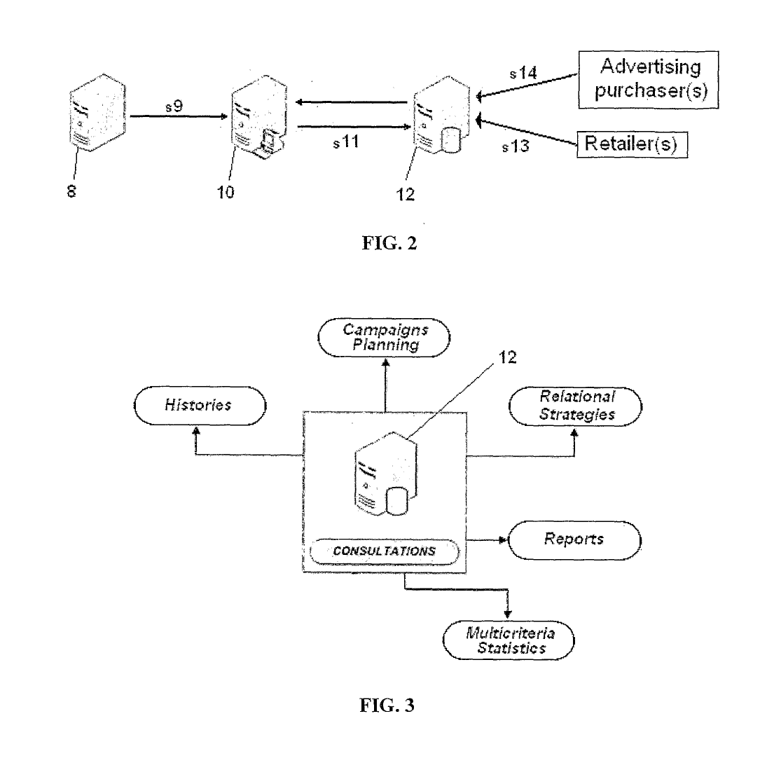

FIG. 2 shows a flow diagram of the general computing process in accordance with one or more embodiments of the invention. The retailer's sales data are extracted from management software stored on the retailer's server (8), and then transmitted to the server of the intermediary as electronic files, such as CSV files (i.e., comma-separated values files), (s9). The data transmission may be accomplished via a virtual private network (VPN). The data sent by the retailers often have different formats, which imply that the data need to be transformed and adapted before being used.

Next, the data is processed. In one or more embodiments of the invention, the data is transformed into SQL files (i.e., structured query language files). The extraction and transformation may be performed using a business intelligence software that works with an ETL principle (i.e., extract-load-transform principle). In some embodiments, a software that could be used to transform the data is Talend Studio (http://www.talend.com). The goal of this process is to centralize all the sales data collected from the different retailers' servers in order to coherently adapt the data in a database situated in the intermediary's server. The business intelligence software should be configured to be compatible with all the various management software used by the retailers. The goal of the extraction and transformation process is to only maintain, from the sales data files, the essential information, such as designation of the product, sales price and number of items sold during a definite amount of time. In some embodiments, the sales data collection may be performed using paper forms which require completion by the retailer and are then faxed weekly to the intermediary.

In one embodiment, a CRM application (i.e., customer relationship management application) is used to provide an interface between the intermediary, and the advertising purchaser and/or retailer. In one embodiment of the present application, the business intelligence software and the CRM application (not shown) are located on different servers as shown in FIG. 2. In one embodiment, the transformation of the sales data is performed on a first server (10). The transformed data are then transmitted (s11) to a second server (12) to be exploited in the CRM application. This configuration allows for a considerable decrease of material means, thereby allowing for an increase in the reactivity and availability of the computing resources. The configuration also ensures the safety and accuracy of the whole system of computing resources.

Continuing with FIG. 2, the CRM application allows the processed data to be sorted as a function of the campaign parameters, the profile of the retailers, and the features of the point-of-sale packaging. In one embodiment, the CRM application provides to the advertising purchaser an evaluation of the impact of the advertising campaign on the advertised products' sales volume.

The CRM application compiles and stores all the available data, results and analysis in real time, and uses such data, results and analysis to provide the advertising purchaser and the retailer with various outputs. As shown on FIG. 3, the CRM application located on the intermediary second server (12) may provide histories, multicriteria statistics, campaigns plannings, and relational strategies. The histories compile sales data, result, analysis that are collected, processed and provided by the CRM application. These histories may be drawn up as a function of various elements, such as the advertised product, the type of advertised product, the advertising purchaser, the drugstore. A second output format is multicriteria statistics that are calculated and displayed as spreadsheets by the GRIM application. The statistics are a function of any criterion, such as the daily or weekly sales, the size of the point-of-sale packaging (small, medium, and large). A third output format, which may be provided by the CRM application, is campaign planning materials which are created thanks to all the data and results stored in the CRM database and are ideal planning materials that may be provided to the advertising purchaser as accurate solutions for future advertising campaigns. These ideal planning materials are described in terms of, for example, point-of- sale packaging solution (number and size), duration of the campaign, the retailers' profile, and may be set up as a function of the advertising purchaser budget. Finally, the relational strategies provided by the CRM application are set up using the information stored in the CRM database, such as the statistical data calculated by the CRM application. These relational strategies provide the advertising purchaser with adapted strategies to launch a new product in order to optimize the contact with the customers, and may be set up as a function of the advertising purchaser's budget.

The CRM application enables the advertising purchaser to compare the sales results and the intensity of its marketing effort. Thus, the CRM application also allows the advertising purchaser to define new campaigns by adjusting the parameters of the campaign, the profile of the at least one retailer, and the features of the point-of-sale packaging as a function of the provided evaluation in order to improve the results of the next advertising campaign(s).

The CRM application may be characterized as an integrator which provides outputs, representing business intelligence, to the advertising purchaser. This business intelligence helps the decision-making process for future campaigns and marketing strategies of the advertising purchaser.

In one embodiment of the invention, the parameters of the advertising campaign are at least one of the number of point-of-sale packaging provided to the at least one retailer and the duration of the advertising campaign.

Returning to FIG. 2, the second server (12) further provides a web interface allowing the advertising purchaser and the retailer to access the database in real time, i.e., at any moment before, during, and after the campaign as the database may be updated daily with daily sales data extracted from the retailers' server, (s13 and s14). This functionality provides the advertising purchaser and the retailer with a dynamic monitoring of the results of the advertising campaign. Accordingly, the advertising purchaser is able, for example, to follow the return on investment of its advertising campaigns and also to monitor the evolution of the advertised products' sales volume.

In one or more embodiments of the invention, the intermediary may introduce some conditions in its business relationship with the advertising purchaser, such as a payment or at least a compensation in return for the intermediary's securing advertising exposure to the retailer's customers for the benefit of the advertising purchaser as well as for the provided evaluation of the impact of the advertising purchaser's advertising campaigns.

### EXAMPLE

The following example was carried out in December 2001, in Colmar (Alsace, France), in two drugstores. 2000 shopping bags were provided to a first drugstore and none to a second drugstore. The shopping bags bore an advertising message related to a drug against skin irritation and baby diaper rash, and were provided in three different sizes which may be referred as small, medium and large. The shopping bags were distributed to all the first drugstore's customers in order for them to carry their purchased goods. The size of the bag was chosen individually, as a function of the quantity of medications or other products bought by the customer.

Once the first drugstore had agreed to participate in the business relationship with the intermediary and once the second drugstore had agreed to be a point of reference, a start date of the advertising campaign was set. During the two weeks prior to and after the advertising campaign, and during the two-week advertising campaign, the two drugstores' employees entered daily the advertised product sales data in the drugstores' management software on the drug store's servers via a keyboard. Daily, i.e., in real time, the business intelligence software on the intermediary first server extracted the sales data from the retailers' servers, loaded and transformed the sales data to be in usable form for the CRM application. Then, the CRM application obtained the collected transformed data on a daily basis, and outputs were provided to the advertising purchaser and the retailers daily. Table 1 summarizes the sales data of the advertised product collected daily from the first drugstore during the two week advertising campaign, and during two weeks prior and after the advertising campaign.

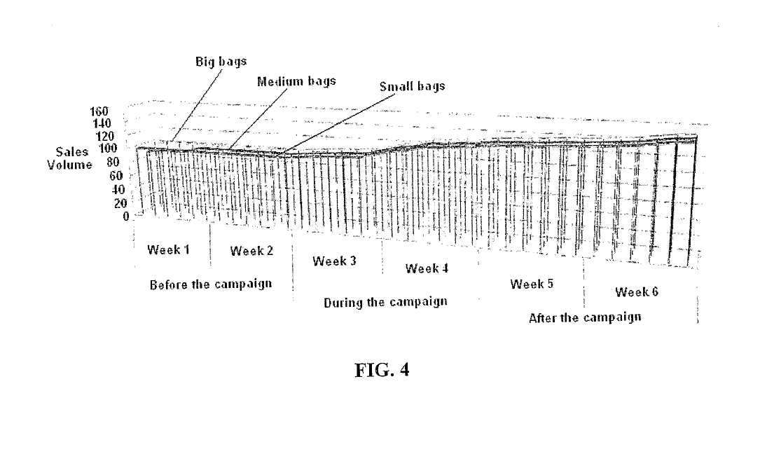

The outputs provided by the CRM application may be of various types. One simple output format is shown on FIG. 4. FIG. 4 illustrates a chart showing the results of Table 1 and shows the evolution of the sales volume of the advertised product in the first drugstore. It may first be observed that, before the advertising campaign, the sales volume of the to-be-advertised product is of 100. During the advertising campaign, the advertised product sales volume increased to 125, whatever bag type was used. After the campaign, the sales volume continued to increase up to 148, whatever bag type was used. It may be concluded, that during the campaign, the sales volume increased 25% and that, during the two weeks after the campaign, the increase continued up to 48%, thus showing an effect of memorization, with a return to the drugstore, of the advertising campaign using shopping bags.

Conversely, it was observed that the studied product sales volume of the second drugstore decreased 5%.

Further, embodiments of the computer system, disclosed herein, for evaluating an impact of an advertising campaign, defined by given campaign parameters, on a sales volume of a product, the computer system comprises a memory; a storage device configured to collect data concerning said sales volume of said product; a processor for executing instructions stored in the memory to process and sort said data as a function of the given campaign parameters, a given profile of at least one retailer, and given features of point-of-sale packaging, to obtain an evaluation of the impact of the advertising campaign on said sales volume of said product, wherein said point-of-sale packaging, with the given features and bearing at least one advertising message related to said product, are given to the at least one retailer with the given profile.

In some embodiments of the present application, the computer systems may further comprise a display device configured to display the evaluation of the impact of the advertising campaign.

In some embodiments of the present application, the computer systems may further comprise means for adjusting the given campaign parameters, the given profile of the at least one retailer, and the given features of the point-of-sale packaging as a function of the evaluation.

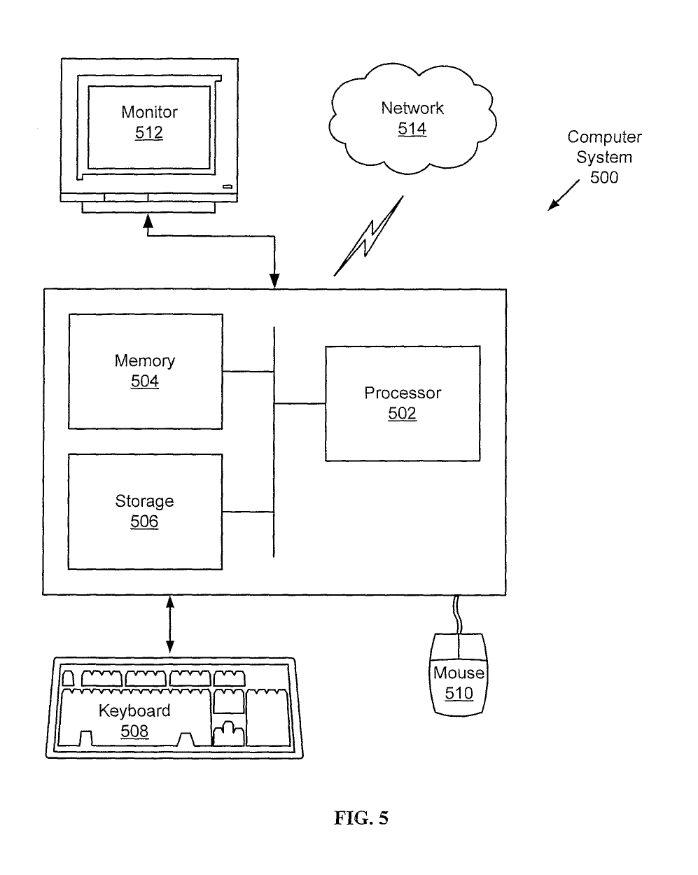

Embodiments of the invention may be implemented on virtually any type of computer regardless of the platform being used. For example, as shown in FIG. 5, a computer system (500) includes one or more processor(s) (502), associated memory (504) (e.g., random access memory (RAM), cache memory, flash memory, etc.), a storage device (506) (e.g., a hard disk, an optical drive such as a compact disk drive or digital video disk (DVD) drive, a flash memory stick, etc.), and numerous other elements and functionalities typical of today's computers (not shown). The computer (500) may also include input means, such as a keyboard (508), a mouse (510), or a microphone (not shown). Further, the computer (500) may include output means, such as a monitor (512) (e.g, a liquid crystal display (LCD), a plasma display, or cathode ray tube (CRT) monitor). The computer system (500) may be connected to a network (not shown) (e.g., a local area network (LAN), a wide area network (WAN) such as the Internet, or any other similar type of network) with wired and/or wireless segments via a network interface connection (not shown). Those skilled in the art will appreciate that many different types of computer systems exist, and the aforementioned input and output means may take other forms. Generally speaking, the computer system (500) includes at least the minimal processing, input, and/or output means necessary to practice embodiments of the invention.

Further, those skilled in the art will appreciate that one or more elements of the aforementioned computer system (500) may be located at a remote location and connected to the other elements over a network. Further, embodiments of the invention may be implemented on a distributed system having a plurality of nodes, where each portion of the invention (e.g., various modules of FIG. 2 and FIG. 3) may be located on a different node within the distributed system. In one embodiments of the invention, the node corresponds to a computer system. Alternatively, the node may correspond to a processor with associated physical memory. The node may alternatively correspond to a processor with shared memory and/or resources. Further, software instructions for performing embodiments of the invention may be stored on a computer readable medium such as a compact disc (CD), a diskette, a tape, a file, or any other computer readable storage device.

Advantageously, embodiments of the present disclosure may provide for at least one of the following. Embodiments of the present application allow a retailer to evaluate the impact of an advertising campaign related to a product on the sales volume of said product. Embodiments of the present disclosure allow the decision-makers to more effectively tailor marketing efforts and successfully reach the desired target market while conserving scarce advertising capital.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for evaluating an impact of an advertising campaign, defined by given campaign parameters, on a sales volume of a product, the method comprising:
providing point-of-sale packaging, with given features and bearing at least one advertising message related to said product, to at least one retailer with a given profile;
collecting data concerning the sales volume of the product;
executing a processor to process and sort the data as a function of the given campaign parameters, the given profile of the at least one retailer, and the given features of the point-of-sale packaging, to obtain an evaluation of the impact of the advertising campaign on the sales volume of the product.

2. The method of claim 1, wherein the method further comprises:
adjusting the given campaign parameters, the given profile of the at least one retailer, and the given features of the point-of-sale packaging as a function of the evaluation.

3. The method of claim 1, wherein the point-of-sale packaging is a shopping bag.

4. The method of claim 1, wherein the advertising campaign is ordered by an advertising purchaser.

5. The method of claim 4, wherein the advertising purchaser is a pharmaceutical company.

6. The method of claim 5, wherein the retailer is a drugstore.

7. The method of claim 1, wherein the profile of the at least one retailer is characterized by at least one of its geographical location, a sales volume, and a number of clients per day.

8. The method of claim 1, wherein the features of the point-of-sale packaging are at least one of a size and a number of faces of the point-of-sale packaging bearing the advertising messages.

9. The method of claim 1, wherein the campaign parameters are at least one of a predetermined number of point-of-sale packaging elements provided to the at least one retailer and the duration of the advertising campaign.

10. The method of claim 1, wherein the sales data are collected before, during and after the advertising campaign.

11. The method of claim 10, wherein the sales data are collected daily.

12. The method of claim 10, wherein the sales data are collected a predetermined period before and after the advertising campaign.

13. The method of claim 10, wherein the advertising campaign spans a predetermined period.

14. A computer system for evaluating an impact of an advertising campaign, defined by given campaign parameters, on a sales volume of a product, the computer system comprising:
a memory;
a storage device configured to collect data concerning said sales volume of said product;
a processor for executing instructions stored in the memory to process and sort said data as a function of the given campaign parameters, a given profile of at least one retailer, and given features of point-of-sale packaging, to obtain an evaluation of the impact of the advertising campaign on said sales volume of said product,
wherein said point-of-sale packaging, with the given features and bearing at least one advertising message related to said product, are given to the at least one retailer with the given profile.

15. The computer system of claim 14, further comprising:
a display device configured to display the evaluation of the impact of the advertising campaign.

16. The computer system of claim 14, further comprising:
means for adjusting the given campaign parameters, the given profile of the at least one retailer, and the given features of the point-of-sale packaging as a function of the evaluation.

17. The computer system of claim 14, wherein the advertising campaign is ordered by an advertising purchaser.

18. The computer system of claim 14, wherein the profile of the at least one retailer is characterized by at least one of its geographical location, a sales volume, and a number of clients per day.

19. The computer system of claim 14, wherein the features of the point-of-sale packaging are at least one of a size and a number of faces of the point-of-sale packaging bearing the advertising messages.

20. The computer system of claim 14, wherein the campaign parameters are at least one of a predetermined number of point-of-sale packaging elements provided to the at least one retailer and the duration of the advertising campaign.

21. The computer system of claim 14, wherein the sales data are collected before, during and after the advertising campaign.

22. The computer system of claim 21, wherein the sales data are collected daily.

23. The computer system of claim 21, wherein the sales data are collected a predetermined period before and after the advertising campaign.
